(19) United States
(12) Patent Application Publication
(10) Pub. No.: US 2004/0249991 A1
(43) Pub. Date: Dec. 9, 2004

(54) Cable detection using cable capacitance

(75) Inventors: Ahmad A.J. Ali, Austin, TX (US); Ahsan Habib, Pflugerville, TX (US)

Correspondence Address: BAKER BOTTS, LLP, 910 LOUISIANA, HOUSTON, TX, 77002-4995, US

(73) Assignee: Dell Products L.P.

(21) Appl. No.: 10/453,092

(22) Filed: Jun. 3, 2003

(51) Int. Cl. G06F 3/00

(52) U.S. Cl. 710/5

(57) ABSTRACT

An external interface cable is detected when the capacitance of the interface cable causes enough phase delay in a clock waveform being compared to the same clock waveform not being phase delayed to indicate the presence of the external interface cable connected to an external interface connector.

### BACKGROUND OF THE INVENTION TECHNOLOGY

1. Field of the Invention

The present invention is related to information handling systems, and more specifically, to detecting when an interface cable is connected to the information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

The information handling system may be connected to other peripheral subsystems, e.g., disk drives, tape drives, compact disk (CD) drives and the like. Connection to these peripheral subsystems may be made through cables adapted for coupling together industry standard interfaces, e.g., SCSI and the like, of the information handling system and the peripheral subsystems. Generally, when the information handling system and a peripheral subsystem are coupled together with an interface cable, a connection pin of the interface cable is grounded so as to indicate that the interface cable has interconnected the information handling system to the peripheral subsystem. However, when an interface cable is disconnected from a peripheral subsystem but not disconnected from the information handling system there is no way for the information handling system industry standard interface to determine whether the un-terminated interface cable remains connected thereto.

In the information handling system, for example, the SCSI interface bus may be routed to more than one place in the information handling system, e.g., on board SCSI interfaces and multiple external SCSI interface connectors adapted for connection to the external peripheral subsystems. The information handling system may have isolation switches at each external interface connector so that the un-terminated interface connectors are decoupled (disconnected) from the interface bus. A problem exists, however, when the various external interface connector isolation switches are controlled by detection of a logic state on a signal pin of the bus. The interface bus, generally, has common signals associated with all of the interfaces coupled thereto, thus individual external connector isolation switches cannot determine whether an un-terminated cable remains connected to it if another external connector has a terminated cable coupled thereto. Having a connected but un-terminated cable coupled to an interface bus may result in signal degradation or intermittent errors in operation of devices on the interface bus.

### SUMMARY OF THE INVENTION

The present invention remedies the shortcomings of the prior art by providing a method, system and apparatus for detecting when an un-terminated interface cable is connected to external connector of an interface bus, e.g., SCSI interface bus. The wires in an interface cable have capacitance associated therewith. When the interface cable is connected to an external connector of the interface bus, it thereby adds capacitance to the connector signal pins. By detecting this added capacitance at a signal pin of the external connector, a determination can be made that a cable is connected thereto. If no other indication that the other end of the cable has been connected to a peripheral subsystem (terminated with a signal pin grounded), then switches may disconnect the external interface connector from the interface bus.

In an exemplary embodiment of the present invention, a clock signal is generated and coupled to a signal pin of the external interface connector through a series resistor, R. The clock signal is also coupled to a first input of a waveform comparison circuit, and the signal pin of the external interface connector is coupled to a second input of the waveform comparison circuit. When there is substantially no capacitance (no external cable connected thereto) at the signal pin of the external interface connector, the clock signals at the first and second inputs of the waveform comparison circuit arrive and change logic levels at the same time, whereby the waveform comparison circuit output remains at a first logic level (both inputs have waveforms that are substantially at the same logic levels all of the time).

When an interface cable is connected to the external interface connector, it adds a shunt (parallel) capacitor, C, to the series resistor, R, at the signal pin of the interface connector. The series resistor and cable shunt capacitor, C, form a low pass filter having an RC time constant that delays the clock signal in time at the second input of the waveform comparison circuit. The logic levels at the first and second inputs of the waveform comparison circuit thereby change at different times, whereby the waveform comparison circuit output toggles between the first logic level and a second logic level (whenever the first and second inputs are at different logic levels). A filter may be coupled to the output of the waveform comparison circuit to further smooth the toggling logic levels into a steady signal that may be applied to inverting amplifier having an output that is at a first logic level when the external interface cable is connected to the interface connector and at a second logic level when no external interface cable is connected. From this inverter output the external connector disconnect switches may be controlled, thereby de-coupling an external interface cable that is not coupled to a peripheral subsystem.

According to an exemplary embodiment of the present invention, an information handling system having at least one interface bus coupled to an external connector, comprises: a processor; an interface controller coupled to the processor, the interface controller being coupled to an interface bus; at least one external interface connector coupled to the interface bus; and a capacitance detection circuit coupled to a signal pin of the at least one external interface connector, wherein when an interface cable is coupled to the at least one external interface connector the interface cable capacitance is detected by the capacitance detection circuit. The capacitance detection circuit comprises: an oscillator; a logic waveform comparison circuit having a first input coupled to the oscillator and a second input coupled to the signal pin of the at least one external interface connector; and a resistor coupled between the oscillator and the second input of the logic waveform comparison circuit, wherein when there is substantially no external cable capacitance coupled to the signal pin of the at least one external interface connector the logic waveform comparison circuit has an output at a first logic level, and when there is external cable capacitance coupled to the signal pin of the at least one external interface connector the logic waveform comparison circuit has an output at a second logic level. The logic waveform comparison circuit may comprise: a NOR gate; an inverter having an input coupled to the NOR gate output; and a filter circuit coupled to the inverter input, wherein the filter circuit smoothes out pulses from the output of the NOR gate. The logic waveform comparison circuit may also comprise: a XOR gate; a buffer having an input coupled to the XOR gate output; and a filter circuit coupled to the buffer input, wherein the filter circuit charges up to a second logic level when there are logic level pulses from output of the XOR gate. The interface controller may be a SCSI controller, the interface bus may be a SCSI bus, and the at least one external interface connector may be at least one SCSI connector. The at least one external interface connectors each may have a capacitance detection circuit coupled to a signal pin thereof. When the interface cable capacitance is detected and the interface cable is not terminated, the at least one external interface connector may be decoupled from the interface bus.

According to another exemplary embodiment of the present invention, an apparatus for detecting capacitance coupled to a signal pin of an external interface connector, comprises: a capacitance detection circuit coupled to a signal pin of an external interface connector, wherein when an interface cable is coupled to the at least one external interface connector the interface cable capacitance is detected by the capacitance detection circuit. The capacitance detection circuit comprises: an oscillator; a logic waveform comparison circuit having a first input coupled to the oscillator and a second input coupled to the signal pin of the external interface connector; and a resistor coupled between the oscillator and the second input of the logic waveform comparison circuit, wherein when there is substantially no external cable capacitance coupled to the signal pin of the external interface connector the logic waveform comparison circuit has an output at a first logic level, and when there is external cable capacitance coupled to the signal pin of the external interface connector the logic waveform comparison circuit has an output at a second logic level. The logic waveform comparison circuit may be comprised of a NOR gate; an inverter having an input coupled to the NOR gate output; and a filter circuit coupled to the inverter input, wherein the filter circuit smoothes out pulses from the output of the NOR gate. The logic waveform comparison circuit may be comprised of a XOR gate; a buffer having an input coupled to the XOR gate output; and a filter circuit coupled to the buffer input, wherein the filter circuit charges up to a second logic level when there are logic level pulses from the output of the XOR gate.

According to still another exemplary embodiment of the present invention, a method for detecting when a cable is connected to an external connector of an information handling system, said method comprising the steps of: applying an oscillating waveform to a first input of a logic waveform comparison circuit; applying the oscillating waveform through a resistor to a second input of the logic waveform comparison circuit; coupling a signal pin of an external interface connector to the second input of the logic waveform comparison circuit; and comparing the phase relationship of the waveforms at the first and second inputs of the logic waveform comparison circuit such that when substantially no external capacitance is coupled to the signal pin of the external interface connector, the logic waveform comparison circuit has an output at a first logic level, and when an external capacitance is coupled to the signal pin of the external interface connector, the logic waveform comparison circuit has an output at a second logic level. The step of comparing may comprise the steps of: logically combining the oscillating waveforms at the first and second inputs in a NOR gate having an output waveform duty cycle dependent upon the phase difference between the oscillating waveforms at the first and second inputs; and filtering the NOR gate output waveform, wherein when there is substantially no phase difference between the oscillating waveforms at the first and second inputs, the filtered output is at the first logic level, and when there is a phase difference between the oscillating waveforms at the first and second inputs, the filtered output is at the second logic level. The step of comparing may comprise the steps of: logically combining the oscillating waveforms at the first and second inputs in a XOR gate having an output dependent upon the phase difference between the oscillating waveforms at the first and second inputs; and charging a capacitor from the XOR gate output waveform, wherein when there is substantially no phase difference between the oscillating waveforms at the first and second inputs, the capacitor is charged at the first logic level, and when there is a phase difference between the oscillating waveforms at the first and second inputs, the capacitor is charged to the second logic level. The method may further comprise the step of decoupling the interface cable from the external connector when the interface cable capacitance is detected and the interface cable is not terminated.

A technical advantage of the present invention is de-coupling an external interface cable when it is not coupled to an external peripheral subsystem. Another technical advantage is detecting the presence of a cable connected to an external interface connector.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic block diagram of an exemplary embodiment of an information handling system;

FIG. 2 is a schematic block diagram of an exemplary information handling system of FIG. 1 having external interface connectors and a peripheral subsystem;

FIG. 3 is a schematic diagram of an exemplary embodiment of the present invention; and

FIG. 4 is a schematic diagram of another exemplary embodiment of the present invention.

The present invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of exemplary embodiments of the present invention are schematically illustrated. Like elements in the drawings will be represented by like numbers, and similar elements will be represented by like numbers with a different lower case letter suffix.

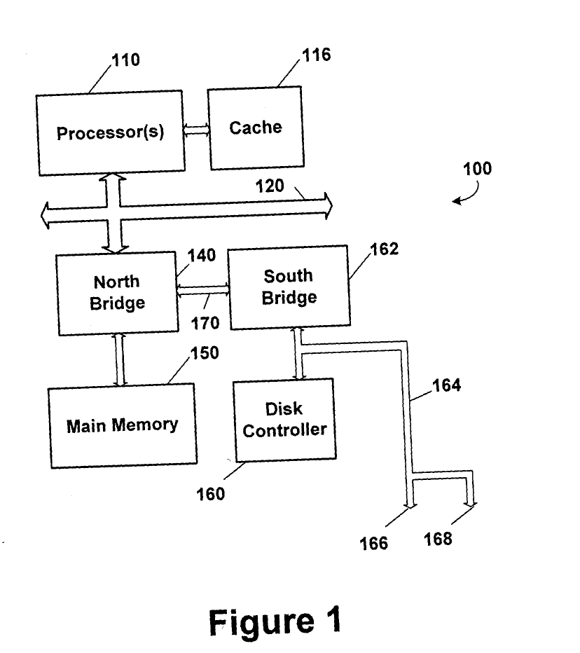

Referring to FIG. 1, an information handling system is illustrated having electronic components mounted on at least one printed circuit board (PCB) and communicating data and control signals therebetween over signal buses. In one embodiment, the information handling system is a computer system. The information handling system, generally referenced by the numeral 100, comprises a processor(s) 110 coupled to a host bus(es) 120 and a cache memory 116. A north bridge(s) 140, which may also be referred to as a memory controller hub or a memory controller, is coupled to a main system memory 150. The north bridge 140 is coupled to the system processor(s) 110 via the host bus(es) 120. The north bridge 140 is generally considered an application specific chip set that provides connectivity to various buses, and integrates other system functions such as a memory interface. For example, an Intel 820E and/or 815E chip set, available from the Intel Corporation of Santa Clara, Calif., provides at least a portion of the north bridge 140. The chip set may also be packaged as an application specific integrated circuit (ASIC). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170, AGP bus coupled to graphics display (not shown), etc. The second bus may also comprise other industry standard buses or proprietary buses, e.g., ISA, SCSI, USB buses 168 through a south bridge (bus interface) 162. These secondary buses 168 may have their own interfaces and controllers, e.g., ATA disk controller 160 and external interface connectors 170 and 172. The external interface connectors 170 and 172 are adapted for coupling the secondary bus 168 to external peripheral subsystems (not shown).

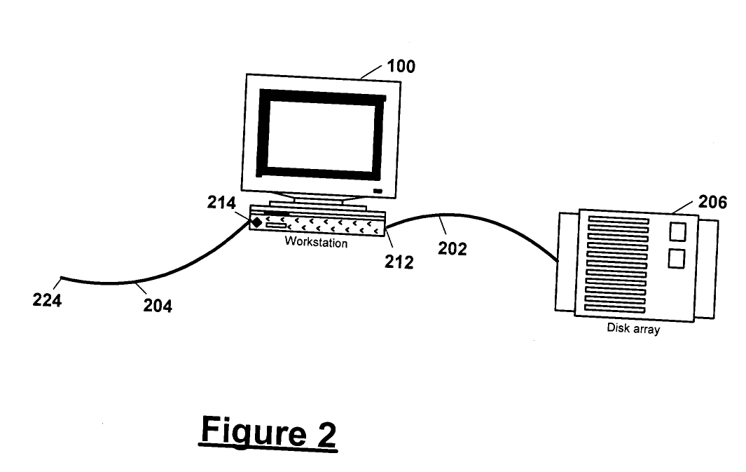

Referring to FIG. 2, depicted is a schematic block diagram of an exemplary information handling system of FIG. 1 having external interface connectors and a peripheral subsystem. The information handling system 100 (PC workstation pictured) is coupled to an external peripheral subsystem 206 (a disk array) with a bus interface cable 202, e.g., SCSI cable. The bus interface cable 202 is connected to a first bus interface connector 212 and to the external peripheral subsystem 206. Another bus interface cable 204 is attached to a second bus interface connector 214 on the information handling system, but is not terminated (not connected) to another external peripheral subsystem. The un-terminated cable 204 may act as a transmission line stub causing undesirable waveform distortion, standing waves and other types of glitches that could seriously degrade the signal integrity of the bus interface.

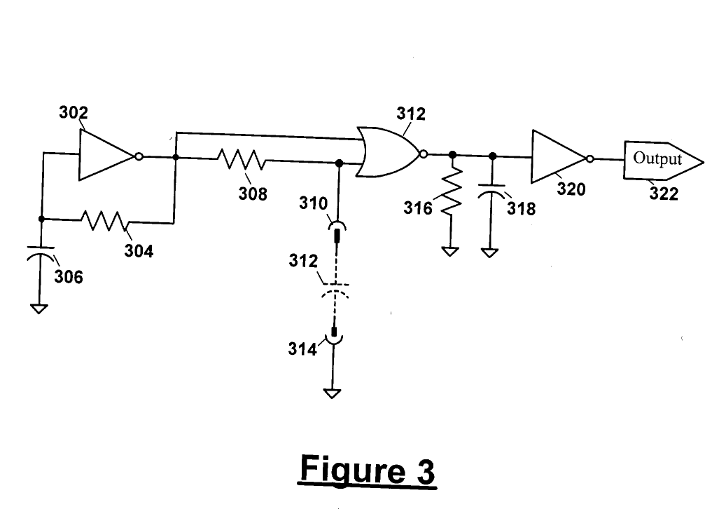

Referring to FIG. 3, depicted is an exemplary embodiment of the present invention. An inverter 302 is configured as an RC oscillator using timing components, resistor 304 and capacitor 306. The inverter 302 may be, for example, a Schottky inverter. Other clock generation circuits may be used and are contemplated herein. The output of the oscillator (inverter 302) is applied directly to a first input of a NOR gate 312 and to a resistor 308 which is also coupled to a second input of the NOR gate 312. The second input of the NOR gate 312 is also coupled to a signal pin 310 of an interface bus external connector (see FIG. 1, connectors 170 and 172). Normally, when there is substantially no capacitance 312 coupled to the second input of the NOR gate 312, the oscillator signal at the second input of the NOR gate 312 will be substantially in phase with the oscillator signal at the first input of the NOR gate 312. Therefore, the signal waveform period at the output of the NOR gate 312 will be substantially the same, but inverted, as the oscillator waveform period, e.g., about a 50 percent duty cycle. Whenever there is a logic level high at an input of the NOR gate 312, the output of the NOR gate 312 will be at a logic level low. The capacitor 318 and resistor 316 may be selected to maintain a voltage during a 50 percent duty cycle from the output of the NOR gate 312 sufficient for the inverter 320 input to remain at a logic level high throughout the oscillator waveform period, thereby resulting in the inverter 320 output remaining at a logic level low.

When a capacitance 312 is added between signal pin 310 and a ground pin 314 (e.g., interface bus external connectors 170, 172), the capacitance 312 and the resistor 308 form a low pass filter which delays the oscillator signal at the second input of the NOR gate 312. Effectively, this causes the oscillator signal waveform to be delayed in phase (not frequency) at the second input, relative to the first input, of the NOR gate 312. Therefore, the output of the NOR gate 312 will remain at a logic level low longer than if both of the oscillator signals at the inputs (un-delayed at the first input and delayed at the second input) where in phase. When the duty cycle of the NOR gate 312 remains at a logic level low for more than 50 percent of the time, the capacitor 318 will not charge up to a voltage sufficient to maintain a logic level high at the input of the inverter 320, and the inverter 320 output will then remain at a logic level high. Thus, detection of whether an external interface cable is coupled to an external interface connector is indicated at the output terminal 322.

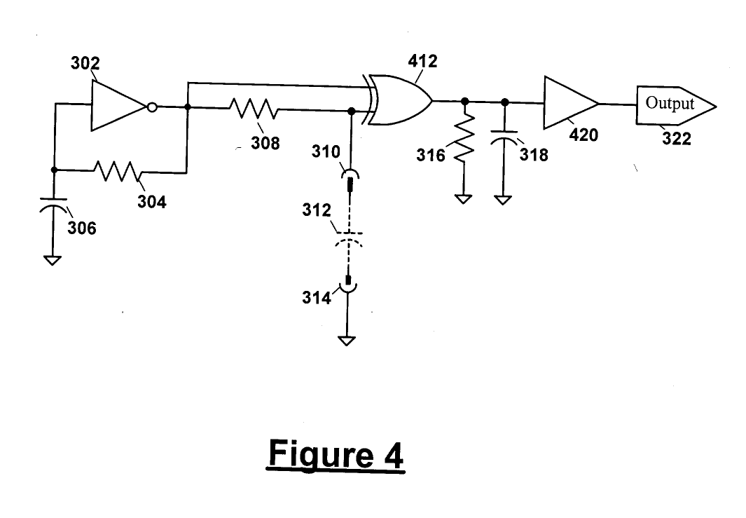

Referring to FIG. 4, depicted is a schematic diagram of another exemplary embodiment of the present invention. An inverter 302 is configured as an RC oscillator using timing components, resistor 304 and capacitor 306. The inverter 302 may be, for example, a Schottky inverter. Other clock generation circuits may be used and are contemplated herein. The output of the oscillator (inverter 302) is applied directly to a first input of a XOR gate 412 and to a resistor 308 which is also coupled to a second input of the XOR gate 412. The second input of the XOR gate 412 is also coupled to a signal pin 310 of an interface bus external connector (see FIG. 1, connectors 170 and 172). Normally, when there is substantially no capacitance 312 coupled to the second input of the NOR gate 312, the oscillator signal at the second input of the XOR gate 412 will be substantially in phase with the oscillator signal at the first input of the XOR gate 412. Therefore, the signal waveform at the output of the XOR gate 412 will be substantially at a logic level low (both input logic levels are the same). Whenever the logic levels are opposite (i.e., one input at logic level high and the other input at logic level low) between the two inputs of the XOR gate 412, the output of the XOR gate 412 will be at a logic level high.

When a capacitance 312 is added between signal pin 310 and a ground pin 314 (e.g., interface bus external connectors 170, 172), the capacitance 312 and the resistor 308 form a low pass filter which delays the oscillator signal at the second input of the XOR gate 412. Effectively, this causes the oscillator signal waveform to be delayed in phase (not frequency) at the second input, relative to the first input, of the XOR gate 412. Therefore, the output of the XOR gate 312 will be at a logic level high whenever the inputs thereof are at different logic levels (i.e., one input at logic level high and the other input at logic level low). The resistor 316 and capacitor 318 may be chosen so that the logic level high pulses from the XOR gate 412 charge the capacitor 318 to a voltage level to the input of the buffer 420 sufficient for the buffer 420 output to remain at a continuous logic level high. When there is substantially no capacitance 312 coupled to the signal pin 310, any output pulses (at a logic level high) from the XOR gate 412 will be of extremely short duration, i.e., not having sufficient pulse width to adequately charge up the capacitor 318. If the capacitor 318 does not charge up enough to reach the minimum logic level high voltage required by the buffer 420, the output of the buffer 420 will remain at a logic level low. Thus, detection of whether an external interface cable is coupled to an external interface connector is indicated at the output terminal 322.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An information handling system having at least one interface bus coupled to an external connector, said system comprising:
a processor;
an interface controller coupled to the processor, the interface controller being coupled to an interface bus;
at least one external interface connector coupled to the interface bus; and
a capacitance detection circuit coupled to a signal pin of the at least one external interface connector, wherein when an interface cable is coupled to the at least one external interface connector the interface cable capacitance is detected by the capacitance detection circuit.

2. The information handling system according to claim 1, wherein the capacitance detection circuit comprises:
an oscillator;
a logic waveform comparison circuit having a first input coupled to the oscillator and a second input coupled to the signal pin of the at least one external interface connector; and
a resistor coupled between the oscillator and the second input of the logic waveform comparison circuit, wherein when there is substantially no external cable capacitance coupled to the signal pin of the at least one external interface connector the logic waveform comparison circuit has an output at a first logic level, and when there is
external cable capacitance coupled to the signal pin of the at least one external interface connector the logic waveform comparison circuit has an output at a second logic level.

3. The information handling system according to claim 2, wherein the logic waveform comparison circuit comprises:
a NOR gate;
an inverter having an input coupled to the NOR gate output; and
a filter circuit coupled to the inverter input, wherein the filter circuit smoothes out pulses from the output of the NOR gate.

4. The information handling system according to claim 2, wherein the logic waveform comparison circuit comprises:
a XOR gate;
a buffer having an input coupled to the XOR gate output; and
a filter circuit coupled to the buffer input, wherein the filter circuit charges up to a second logic level when there are logic level pulses from output of the XOR gate.

5. The information handling system according to claim 1, wherein the interface controller is a SCSI controller, the interface bus is a SCSI bus, and the at least one external interface connector is at least one SCSI connector.

6. The information handling system according to claim 1, wherein each of the at least one external interface connectors has a capacitance detection circuit coupled to a signal pin thereof.

7. The information handling system according to claim 1, wherein when the interface cable capacitance is detected and the interface cable is not terminated, the at least one external interface connector is decoupled from the interface bus.

8. An apparatus for detecting capacitance coupled to a signal pin of an external interface connector, comprising:
a capacitance detection circuit coupled to a signal pin of an external interface connector, wherein when an interface cable is coupled to the at least one external interface connector the interface cable capacitance is detected by the capacitance detection circuit.

9. The apparatus according to claim 8, wherein the capacitance detection circuit comprises:
an oscillator;
a logic waveform comparison circuit having a first input coupled to the oscillator and a second input coupled to the signal pin of the external interface connector; and
a resistor coupled between the oscillator and the second input of the logic waveform comparison circuit, wherein when there is substantially no external cable capacitance coupled to the signal pin of the external interface connector the logic waveform comparison circuit has an output at a first logic level, and when there is external cable capacitance coupled to the signal pin of the external interface connector the logic waveform comparison circuit has an output at a second logic level.

10. The apparatus according to claim 9, wherein the logic waveform comparison circuit comprises:
a NOR gate;
an inverter having an input coupled to the NOR gate output; and
a filter circuit coupled to the inverter input, wherein the filter circuit smoothes out pulses from the output of the NOR gate.

11. The apparatus according to claim 9, wherein the logic waveform comparison circuit comprises:
a XOR gate;
a buffer having an input coupled to the XOR gate output; and
a filter circuit coupled to the buffer input, wherein the filter circuit charges up to a second logic level when there are logic level pulses from the output of the XOR gate.

12. A method for detecting when a cable is connected to an external connector of an information handling system, said method comprising the steps of:
applying an oscillating waveform to a first input of a logic waveform comparison circuit;
applying the oscillating waveform through a resistor to a second input of the logic waveform comparison circuit;
coupling a signal pin of an external interface connector to the second input of the logic waveform comparison circuit; and
comparing the phase relationship of the waveforms at the first and second inputs of the logic waveform comparison circuit such that when substantially no external capacitance is coupled to the signal pin of the external interface connector, the logic waveform comparison circuit has an output at a first logic level, and when an external
capacitance is coupled to the signal pin of the external interface connector, the logic waveform comparison circuit has an output at a second logic level.

13. The method according to claim 12, wherein the step of comparing comprises the steps of:
logically combining the oscillating waveforms at the first and second inputs in a NOR gate having an output waveform duty cycle dependent upon the phase difference between the oscillating waveforms at the first and second inputs; and
filtering the NOR gate output waveform, wherein when there is substantially no phase difference between the oscillating waveforms at the first and second inputs, the filtered output is at the first logic level, and when there is a phase difference between the oscillating waveforms at the first and second inputs, the filtered output is at the second logic level.

14. The method according to claim 12, wherein the step of comparing comprises the steps of:
logically combining the oscillating waveforms at the first and second inputs in a XOR gate having an output dependent upon the phase difference between the oscillating waveforms at the first and second inputs; and
charging a capacitor from the XOR gate output waveform, wherein when there is substantially no phase difference between the oscillating waveforms at the first and second inputs, the capacitor is charged at the first logic level, and when there is a phase difference between the oscillating waveforms at the first and second inputs, the capacitor is charged to the second logic level.

15. The method according to claim 12, further comprising the step of decoupling the interface cable from the external connector when the interface cable capacitance is detected and the interface cable is not terminated.
